(19) United States
(12) Patent Application Publication
(10) Pub. No.: US 2006/0176500 A1
(43) Pub. Date: Aug. 10, 2006

(54) Information processing device

(75) Inventors: Ayako Hosoi, Tokyo (JP); Natsuko Ouchi, Kanagawa (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/236,707

(22) Filed: Sep. 27, 2005

(30) Foreign Application Priority Data
Feb. 8, 2005 (JP) 2005-32168

(51) Int. Cl. G06K 15/00

(52) U.S. Cl. 358/1.14

(57) ABSTRACT

An information processing device which judges that there is a possibility that the device is being left standing depending on the nature of a processing operation while this processing operation is being performed and places an operating lock on the device. The operating lock is placed on the device (step S11d) in cases where a specified time has elapsed with upper and lower housings in a closed state (“elapsed” in step S11b), or in cases where a specified time has elapsed with the device waiting for an operation by a user (“elapsed” in step S11i), and in cases where a processing that is in progress in the device is the processing that is started without any operation performed by the user and that is waiting for an operation by the user, and/or a processing that has a low priority (“only this processing is in progress” in step S11c).

### CROSS-REFERENCE TO RELATED APPLICATIONS

This application is based upon and claims the benefit of priority from the prior Japanese Patent Application No. 2005-32168, filed on Feb. 28, 2005; the entire contents of which are incorporated therein by reference.

### BACKGROUND OF THE INVENTION

1. Field of the Invention

The present invention relates to an information processing device, and more particularly relates to operating locking processing performed when processing operations are performed.

2. Description of the Related Art

Information processing devices that are used exclusively by a single user are known. Examples of such devices include mobile communications terminal devices and electronic notebook devices which have a compact size, and are portable; however, such devices are not limited to these examples. Other examples of such devices include personal computers and the like that are assigned to a single person. Ordinarily, such information processing devices are constantly carried by a user, or, in cases where the user is away from the device, the user places an operating lock on the device. However, there are also cases in which, for example, devices are left on a desk top without placing such an operating lock on the device.

In cases where such devices are left on a desk top and used by persons other than the authorized user, for example, problems such as the possibility of leakage of personal information stored in the device arise. Furthermore, there may also be cases in which such devices are left in briefcases. In cases where such devices are left in briefcases or the like, the keys or the like of the device may come into contact with objects surrounding the device, so that operations contrary to the intentions of the user are performed. Furthermore, problems such as the wasteful consumption of electric power and the like also arise.

Conventionally, therefore, as is disclosed, for example, in Japanese Patent Application Laid-Open No. 2004-343677, processing is known in which a lock is placed on the input operations of the keys or the like of such information processing devices when it is detected that there is a possibility that the device may be left standing in an unused state, and this lock is released by verification based on the input of a specified secret verification number.

However, in the procedure disclosed in the abovementioned Japanese Patent Application Laid-Open No. 2004-343677, an operating lock is not placed on the system in cases where processing operations are performed by the information processing device. As a result, the following problem arises: namely, in cases where a processing operation is being performed by the device, and there is a possibility that the device will be left standing, there is also a possibility that personal information stored in the device will be leaked, since no operating lock is placed on the system.

### SUMMARY OF THE INVENTION

The present invention was devised in order to solve the abovementioned problems, and it is an object of the present invention to provide an information processing device which judges that there is a possibility that the device will be left standing depending on the nature of a processing operation while the processing operation is being performed, and places an operating lock on the device.

In order to achieve the abovementioned object, an aspect of the present invention provides an information processing device including: a processing control unit configured to execute processing that is started without any operation being performed by a user; a detection control unit configured to detect the opening and closing of the device; and a locking control unit configured to lock a key, if a closed state of the device is detected by said detection control unit, and the processing performed by said processing control unit is in progress.

Another aspect of the present invention provides an information processing device including: a processing control unit configured to execute processing that is started without any operation being performed and that accepts an operation performed; a judgment control unit configured to judge whether or not a state in which said processing control unit accepts the operation performed has continued for a specified period of time or longer; and a locking control unit configured to lock a key, if it is judged that the state in which said processing control unit accepts the operation performed has continued for the specified period of time or longer, and the processing performed by said processing control unit is in progress.

A still another aspect of the present invention provides an information processing device including: a processing control unit configured to execute first processing which has a lower priority than second processing based on an operation performed, and which is interrupted if said second processing based on the operation performed is started; a detection control unit configured to detect the opening and closing of the device; and a locking control unit configured to lock a key, if a closed state of the device is detected by said detection control unit, and said first processing performed by said processing control unit is in progress.

Yet still another aspect of the present invention provides an information processing device comprising: a processing control unit configured to execute first processing which has a lower priority than second processing based on an operation performed, and which is interrupted if said second processing based on the operation performed is started; a judgment control unit configured to judge whether or not a state in which no operation is performed has continued for a specified period of time or longer; and a locking control unit configured to lock a key, if it is judged by said judgment control unit that the state in which no operation is performed has continued for a specified period of time or longer, and the first processing performed by said processing control unit is in progress.

According to the abovementioned aspects of the present invention, it is possible to provide an information processing device which judges that there is a possibility that the device may be left standing depending on the nature of a processing operation while this processing operation is being performed, and which places an operating lock on the device.

### BRIEF DESCRIPTION OF THE DRAWINGS

FIG. 1A and FIG. 1B show external views illustrating a state in which upper and lower housings of a first freely-openable folding type mobile communications terminal device constituting an embodiment of the present invention are open, with FIG. 1A showing a front view and FIG. 1B showing a side view;

FIG. 2A and FIG. 2B show external views illustrating a state in which the upper and lower housings of the first freely-openable folding type mobile communications terminal device constituting the embodiment of the present invention are closed, with FIG. 2A showing the front view and FIG. 2B showing the side view;

FIG. 3A and FIG. 3B show external views illustrating a state in which upper and lower housings of a second freely-openable folding type mobile communications terminal device constituting an embodiment of the present invention are open, with FIG. 3A showing a front view and FIG. 3B showing a side view;

FIG. 4A and FIG. 4B show external views illustrating a state in which the upper and lower housings of the second freely-openable folding type mobile communications terminal device constituting the embodiment of the present invention are closed to the inside, with FIG. 4A showing a front view and FIG. 4B showing a side view;

FIG. 5A and FIG. 5B show external views illustrating a state in which the upper housing of the second freely-openable folding type mobile communications terminal device constituting the embodiment of the present invention is pivoted to the outside and closed, with FIG. 5A showing a front view and FIG. 5B showing a side view;

FIG. 6A and FIG. 6B show external views illustrating a state in which the upper housing of the second freely-openable folding type mobile communications terminal device constituting the embodiment of the present invention is pivoted 90 degrees, with FIG. 6A showing a front view and FIG. 6B showing a side view;

FIG. 7A and FIG. 7B show external views illustrating a state in which the upper housing of the second freely-openable folding type mobile communications terminal device constituting the embodiment of the present invention is pivoted until it faces the back surface, and is thus closed, with FIG. 7A showing a front view and FIG. 7B showing a side view;

FIG. 8A and FIG. 8B show external views illustrating a state in which upper and lower housings of a third freely-openable sliding type mobile communications terminal device constituting an embodiment of the present invention are open, with FIG. 8A showing a front view and FIG. 8B showing a side view;

FIG. 9A and FIG. 9B show external views illustrating a state in which the upper and lower housings of the third freely-openable sliding type mobile communications terminal device constituting the embodiment of the present invention are closed, with FIG. 9A showing a front view and FIG. 9B showing a side view;

FIG. 10 is a block diagram showing the construction of a folding type mobile communications terminal device constituting the embodiment of the present invention;

FIG. 11 is a diagram showing one example of the display performed on the display part by the call notification part in the embodiment of the present invention;

FIG. 12 is a diagram showing one example of the display performed on the display part by the image display part in the embodiment of the present invention;

FIG. 13 is a diagram showing another example of the display performed on the display part by the image display part in the embodiment of the present invention; and

FIG. 14 is a flow chart showing the operating lock and operating lock release control operations performed by the control part in the embodiment of the present invention.

### DESCRIPTION OF THE PREFERRED EMBODIMENTS

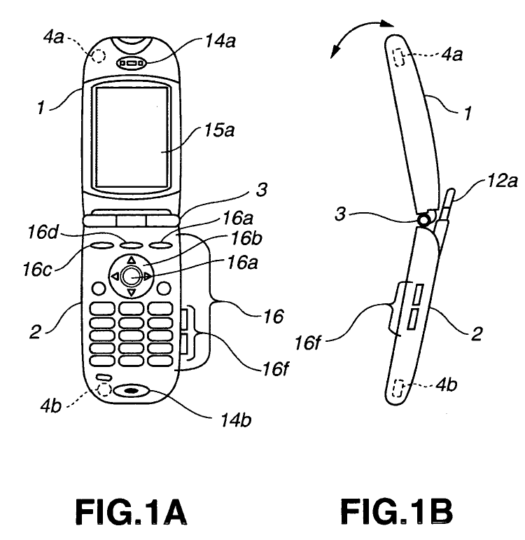

Embodiments of the information processing device of the present invention will be described below with reference to the attached figures. FIG. 1A and FIG. 1B show external views illustrating a state in which the upper and lower housings of a first freely-openable folding type mobile communications terminal device constituting an embodiment of the present invention are open, with FIG. 1A showing a front view and FIG. 1B showing a side view.

This first mobile communications terminal device is constructed so that an upper housing 1 and lower housing 2 are connected by a hinge part 3 so that these housings are free to pivot, thus allowing free opening and closing of the upper and lower housings 1 and 2 between an angle that is substantially 0 degrees (closed state) and an angle that is substantially 180 degrees (open state). A speaker 14a that is used for reception and a display part 15 comprising an LCD (liquid crystal display) equipped with backlighting that is used for a display that prompts operations by the user, a display of the contents of operations performed by the user, a display of the cursor position and operating state of the device and the like are disposed on the inside surface of the upper housing 1. The display part 15 is divided into a cell used to display the state of the device by means of a simple graphic (pict), and a cell in which a display that depends on the content of the operation is performed.

Furthermore, microphone 14b that is used for reception is disposed on the inside surface of the lower housing 2. An input device 16 comprising a key pad is disposed on the inside surface and side surfaces of the lower housing 2. Furthermore, an antenna 12a used for the transmission and reception of electromagnetic waves is disposed on the outside surface of the lower housing 2.

The input device 16 is disposed on the inside surface of the lower housing 2, and includes a warp center key 16a that is used to indicate confirmation or selection in various functions, and a warp cruciform key 16b which is disposed adjacent to the warp center key 16a so as to surround the warp center key 16a, which comprises four keys positioned above, below, to the left and to the right of the warp center key 16a, and which is used to designate movement of the cursor position and the like on the display part 15. Furthermore, this input device 16 also includes a first software key 16c, a second software key 16d and a third software key 16e which are disposed from left to right near the display part 15, i.e., near the upper housing 1, on the inside surface of the lower housing 2, and which are used to select first through third functions displayed from left to right on the display part 15.

Furthermore, the input device 16 also includes numerical keys which are used to input Arabic numerals, English alphabetical characters, symbols or the like, a plurality of function keys which are used to input operating instructions such as the switching on and switching off of the power supply of the mobile communications terminal device and the like, and a plurality of side surface keys 16f which are disposed on the side surfaces of the lower housing 2.

Furthermore, a first opening and closing detection part (not shown in the figures) which detects whether the upper and lower housings 1 and 2 are in an open state or a closed state is disposed on the hinge part 3, and an open/closed signal is output from this first opening and closing detection part.

Furthermore, in order to detect whether the upper and lower housings 1 and 2 are in an open state or a closed state, a magnet 4a is embedded in the upper part of the upper housing 1 (i.e., the portion of the upper housing 1 that is distant from the hinge part 3), a magnet 4b is embedded in the lower part of the lower housing 2 (i.e., the portion of the lower housing 2 that is distant from the hinge part 3), and the system is disposed so that the distance between these magnets 4a and 4b is small when the device is in a closed state. Accordingly, a second opening and closing detection part (not shown in the figures) which detects the state by means of the magnetic force that acts between these magnets 4a and 4b when the device is in a closed state may be installed, and the system may be devised so that and open/closed signal is output from this second opening and closing detection part. Furthermore, whether the upper and lower housings 1 and 2 are in an open state or a closed state may also be detected using both the open/closed signal output from the first opening and closing detection part and the open/closed signal output from the second opening and closing detection part.

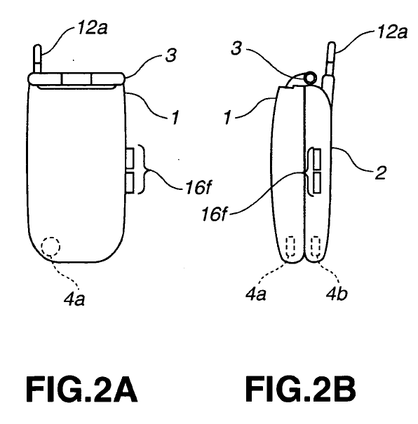

FIG. 2A and FIG. 2B show the external appearance in a case where the upper housing 1 of this first mobile communications terminal device has been caused to pivot by means of the hinge part 3 so that this upper housing 1 approaches the lower housing 2 and closes the folding of the device; FIG. 2A shows a front view, and FIG. 2B shows a side view. In a state in which this folding is closed, the display part 15 and input part 16 are located inside the fold; accordingly, the user cannot visually check the display performed by the display part 15, and cannot operate the keys of the input part 16.

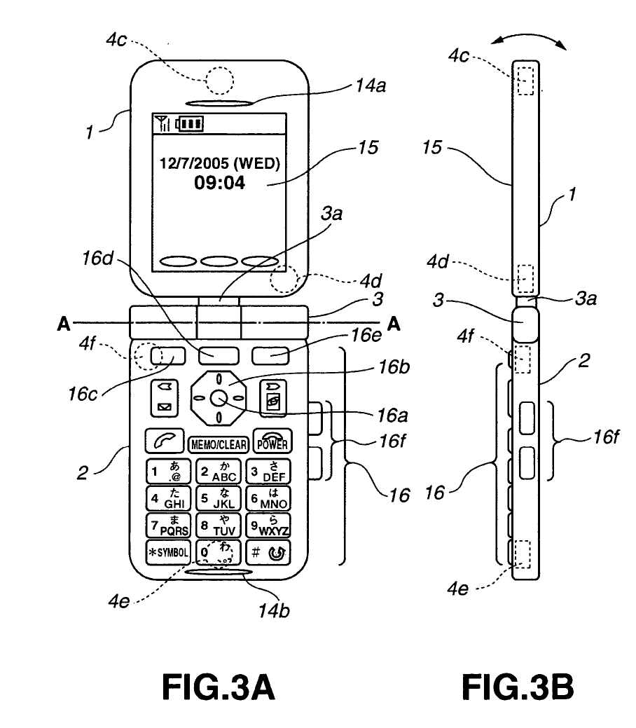

FIG. 3A and FIG. 3B show the external appearance of a second freely-openable folding type mobile communications terminal device using an information processing device constituting an embodiment of the present invention in a state in which the folding of the upper and lower housings 1 and 2 is opened; FIG. 3A shows a front view, and FIG. 3B shows a side view. Furthermore, parts that are the same as in the first freely-openable folding type mobile communications terminal device are labeled with the same symbols, and a description of such parts is omitted.

This second mobile communications terminal device is constructed so that the upper housing 1 and lower housing 2 are connected by the hinge part 3 in a manner that allows free pivoting, so that the angle of the upper and lower housings 1 and 2 can be freely opened and closed from substantially 0 degrees (closed state) through 180 degrees (open state) to substantially 360 degrees (closed state). Furthermore, an antenna (not shown in the figures) is disposed inside the upper and lower housings 1 and 2. Moreover, a second hinge part 3a which connects the upper housing 1 and hinge part 3 so as to allow free pivoting is provided. Furthermore, a third opening and closing detection part (not shown in the figures) which detects the pivoting angle of the upper housing 1 is disposed on the second hinge part 3a, and an open/closed signal is output from this third opening and closing detection part.

Furthermore, in order to detect whether the upper and lower housings 1 and 2 are in an open state or a closed state, two magnets are embedded in the upper housing 1 instead of the magnets 4a and 4b, i.e., a magnet 4c is embedded in the central part of the upper part (the part that is distant from the hinge part 3), and a magnet 4d is embedded in the right end part of the lower part (the part that is close to the hinge part 3). Furthermore, two magnets are embedded in the lower housing 2, i.e., a magnet 4e is embedded in the central part of the lower part (that part that is distant from the hinge part 3), and a magnet 4f is embedded in the left end part of the upper part (the part that is close to the hinge part 3).

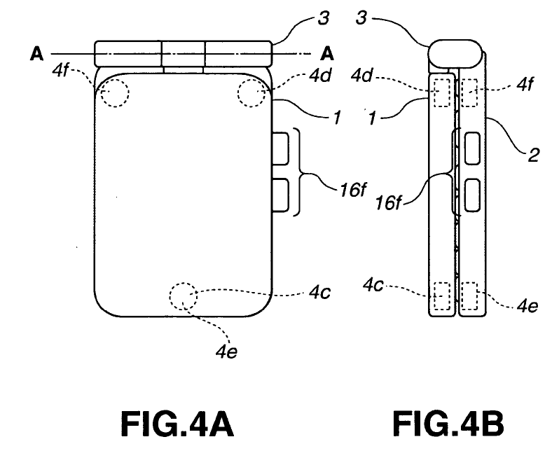

FIG. 4A and FIG. 4B show the external appearance in a case where the upper housing 1 of this second mobile communications terminal device is pivoted by means of the hinge part 3 to the inside about the axis A-A, and is thus folded toward the lower housing 2 and closed; FIG. 4A shows a front view, and FIG. 4B shows a side view. In a state in which the folding is closed to the inside, the display part 15 and input device 16 are on the inside of the fold; accordingly, the user cannot visually confirm the display performed by the display part 15, and cannot operate the keys of the input device 16.

In this case, an open/closed signal indicating that the fold is closed to the inside is output from the first opening and closing detection part. Furthermore, in a state in which the fold is closed to the inside, the distance between the magnets 4c and 4e is small; an open/closed signal indicating this state may also be output from the second opening and closing detection part utilizing the fact that the magnetic force acting between these magnets 4c and 4e is increased.

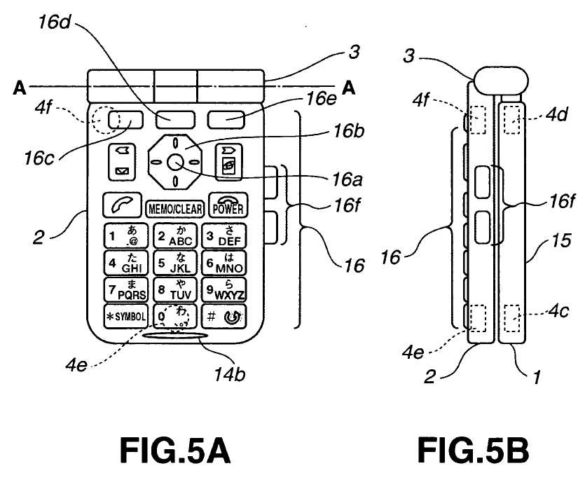

FIG. 5A and FIG. 5B show the external appearance in a case where the upper housing 1 of this second mobile communications terminal device is pivoted by means of the hinge part 3 to the outside about the axis A-A, and is thus folded toward the lower housing 2 and closed; FIG. 5A shows a front view, and FIG. 5B shows a side view. In a state in which the fold is closed to the outside, the display part 15 and input device 16 are located on the outside of the fold; accordingly, the user can visually confirm the display that is performed by the display part 15, and can operate the keys of the input device 16.

However, in the case of the display part 15 and input device 16, as is shown in FIG. 5B, one of these parts is disposed on the front side while the other part is disposed on the back side; accordingly, the user cannot simultaneously make a visual confirmation of both the display part 15 and the input device 16. Furthermore, in a state in which the fold is closed to the outside, an open/closed signal indicating that the device is in a state in which the fold is closed to the outside is output from the first opening and closing detection part. Moreover, in a state in which the fold is closed to the outside, the distance between the magnets 4c and 4e is reduced to a small distance; accordingly, an open/closed signal may be output utilizing the fact that the magnetic force that acts between these magnets 4c and 4e is increased.

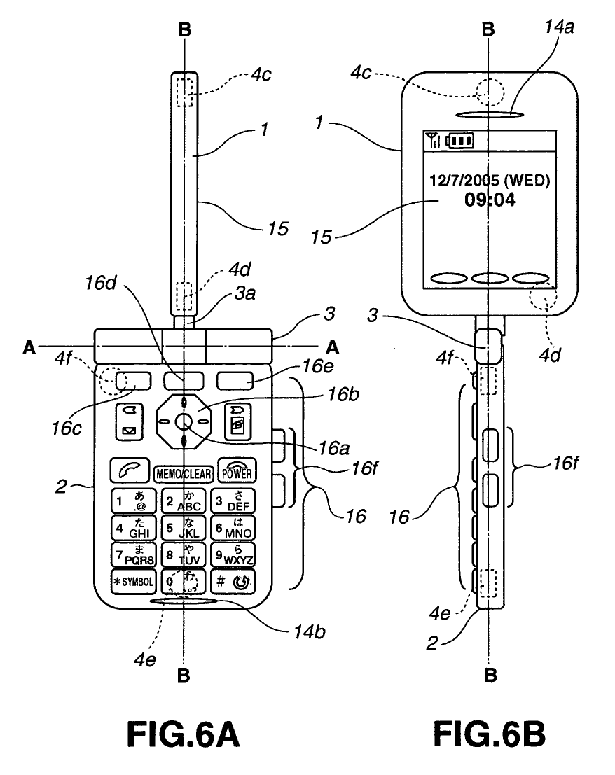

FIG. 6a and FIG. 6B show the external appearance in a case where the upper housing 1 is caused to pivot 90 degrees about the axis B-B (which is perpendicular to the axis A-A) by means of the second hinge part 3a from a state in which the folding of the upper and lower housings 1 and 2 of this second mobile communications terminal device (shown in FIGS. 3A and 3B) is open; FIG. 6A) shows a front view, and FIG. 6B shows a side view. Since the upper housing 1 of this second mobile communications terminal device is connected to the hinge part 3 by the second hinge part 3a so that free pivoting is allowed, the orientation of the upper housing 1 can be caused to pivot from an orientation facing the front surface to an orientation facing the back surface.

In a case where the orientation of the upper housing 1 is caused to pivot to the back surface, the user can visually confirm the display performed by the display part 15, and can operate the keys of the input device 16. However, in the case of the display part 15 and the input device 16, these parts are disposed so that one part is oriented toward the front and the other part is oriented toward the back; accordingly, the user cannot visually confirm the display part 15 and the input device 16 at the same time.

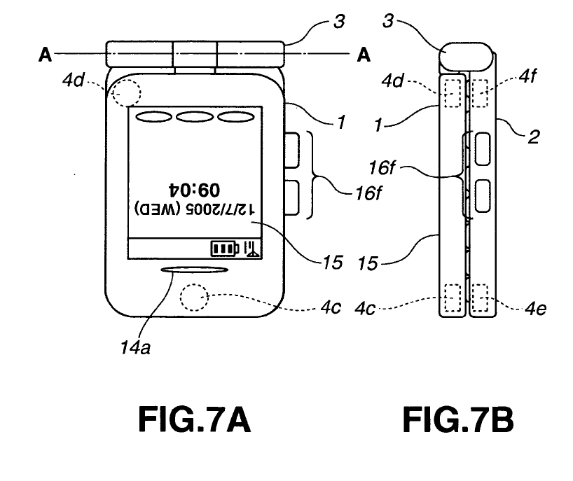

FIG. 7A and FIG. 7B show the external appearance in a case where the upper housing 1 of this second mobile communications terminal device is caused to pivot to a back surface orientation by means of the second hinge part 3a, and the upper housing 1 is then folded to the inside and placed in a closed state by means of the hinge part 3; FIG. 7A shows a front view, and FIG. 7B shows a side view. When the upper housing 1 is folded and placed in a closed state after being caused to pivot to a back surface orientation, the distance between the magnets 4d and 4f is reduced to a small distance, so that the magnetic force that acts between the magnets 4d and 4f is increased. Accordingly, after the upper housing 1 is caused to pivot to a back surface orientation, an open/closed signal indicating that the device has been folded into a closed state is transmitted from the second opening and closing detection part.

In the case shown in FIGS. 7A and 7B where the upper housing 1 is caused to pivot to a back surface orientation and is then folded to the inside and placed in a closed state, the display part 15 is positioned on the outside of the fold, so that the user can visually confirm the display part 15. However, since the input device 16 is positioned on the inside of the fold, the user cannot operate the keys of the input device 16.

Furthermore, the closed state shown in FIGS. 7A and 7B indicates a case in which the upper housing 1 is folded and placed in a closed state after being caused to pivot to a back surface orientation. However, in a case in which the upper housing is folded to the outside and placed in a closed state after being caused to pivot to a back surface orientation, the user can visually confirm the display part 15. In this case, however, since the input device 16 is positioned on the outside of the fold, the user cannot operate the keys of the input device 16.

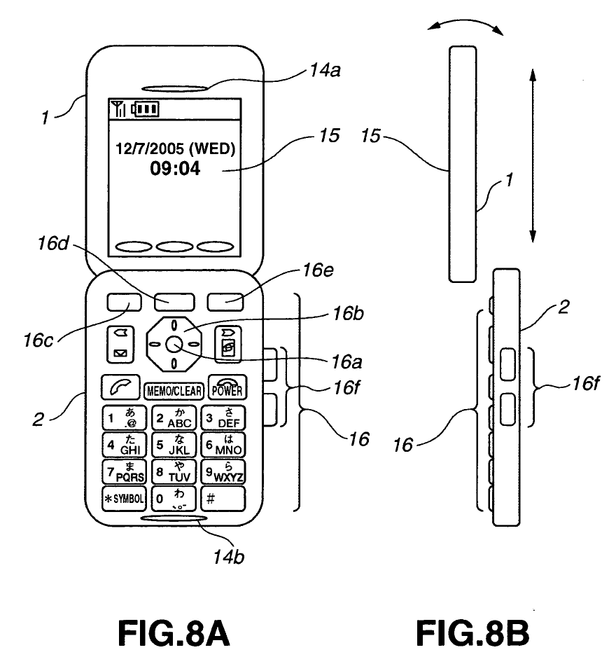

FIG. 8A and FIG. 8B show the external appearance in a case where the sliding of the upper and lower housings 1 and 2 of a third freely-openable sliding type mobile communications terminal device using an information processing device constituting an embodiment of the present invention is open; FIG. 8A shows a front view, and FIG. 8B shows a side view. Furthermore, parts that are the same as in the second mobile communications terminal device (that can be freely opened and closed) are labeled with the same symbols, and a discussion of such parts is omitted.

This third mobile communications terminal device does not have a hinge part 3, second hinge part 3a or magnets 4c through 4f; in this device, the opening and closing operation is accomplished by the sliding of the upper housing 1. Specifically, as a result of the upper housing 1 being caused to slide upward, the input device 16 disposed on the front surface of the lower housing 2 appears, and an open state is achieved. In this open state, the third mobile communications terminal device shows substantially the same external appearance as the second mobile communications terminal device shown in FIG. 3.

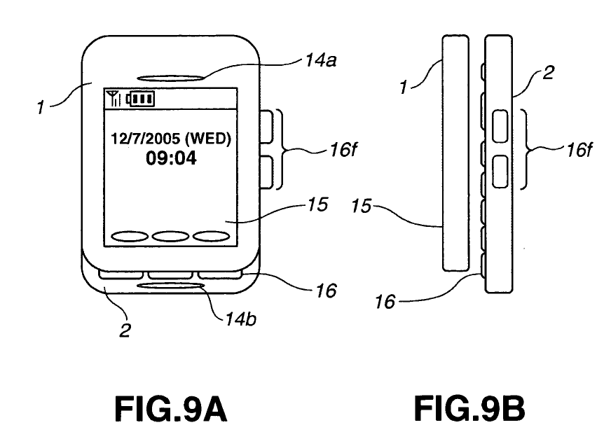

FIG. 9A and FIG. 9B show the external appearance in a case where the sliding of the upper and lower housings 1 and 2 of the third mobile communications terminal device is closed; FIG. 9A shows a front view, and FIG. 9B shows a side view. As a result of the sliding being closed, i.e., as a result of the upper housing 1 being caused to slide downward, the input device 16 disposed on the inside of the lower housing 2 is hidden, and a closed state is achieved.

Furthermore, in the closed state, it is not necessarily the case that all of the keys of the input device 16 disposed on the front surface of the lower housing 2 are hidden. It would also be possible for some of the keys disposed on the front surface of the lower housing 2 to appear as shown in the example illustrated in FIGS. 9A and 9B. Furthermore, some of the keys may be disposed on the lower part of the upper housing 1. A fourth opening and closing detection part (not shown in the figures) is disposed on the sliding part, and an open/closed signal is output from this fourth opening and closing detection part.

Thus, in the closed state of the mobile communications terminal device that can be freely opened and closed, as was described above, four different cases are involved: namely, a case in which the display of the display part 15 cannot be visually confirmed, and the operation of at least one of the keys of the input device 16 is impossible, a case in which the display of the display part 15 can be visually confirmed, and the keys of the input device 16 can be operated, but in which the display part 15 and input device 16 cannot be visually confirmed at the same time since the display part 15 and input device 16 are disposed on the front and back surfaces of the mobile communications terminal device, a case in which the display of the display part can be visually confirmed, but the operation of at least one of the keys of the input device 16 is impossible, and a case in which the display of the display part 15 cannot be visually confirmed, but the keys of the input device 16 can be operated.

The user cannot use the device normally in any of these four cases. Accordingly, it is judged that the user is intentionally not using the device. Furthermore, in cases where key operations can be performed using only some of the keys of the input device 16, and the user cannot use the device normally by means of the keys that do allow key operations, it is judged that the device is in a closed state. In the following description, the term “closed state” refers to one of these cases or an arbitrary plurality of these cases. When the device is not in a closed state, the device is in an open state.

Furthermore, in the above description, it was considered that the side surface keys 16f forming a part of the input device 16 could be operated in a closed state in all of the devices. Furthermore, since it is judged that the user is not intentionally using the device by the operation of only the side surface keys 16f, the operability of the side surface keys 16f alone is considered not to have any effect on the judgment of whether the upper and lower housings 1 and 2 are in an open state or a closed state. However, this does not apply to cases in which the user can positively use the device by the operation of the side surface keys 16f alone. Specifically, the upper and lower housings 1 and 2 are judged to be in an open state or a closed state exclusively on the basis of whether or not the display part 15 can be visually recognized by the user.

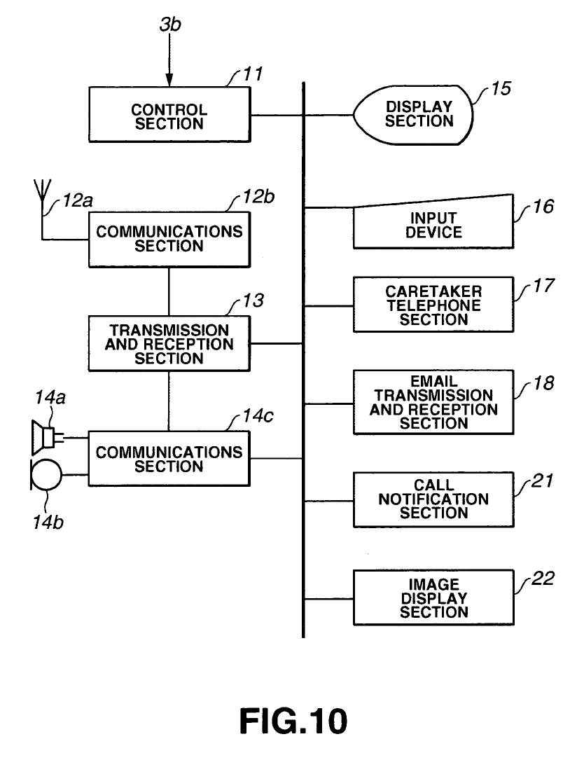

FIG. 10 is a block diagram showing the construction of these mobile communications terminal devices. This mobile communications terminal device comprises a control part 11 which inputs open/closed signals 3b and controls the device as a whole, an antenna 12a which is used to perform the transmission and reception of electromagnetic waves between this device and a base station (not shown in the figures), a communications part 12b, a transmission and reception part 13, a speaker 14a, a microphone 14b, a communications part 14c, a display part 15, an input device 16, a caretaker telephone part 17, an email transmission and reception part 18, a call notification part 21, and an image display part 22.

The operations of the various parts of the mobile communications terminal device of the present embodiment constructed as described above will be described with reference to FIG. 10. First, the communications part 12b outputs high-frequency signals received by the antenna 12a to the transmission and reception part 13; furthermore, high-frequency signals output from the transmission and reception part 13 are transmitted by the antenna 12a.

The transmission and reception part 13 subjects high-frequency signals from the communications part 12b to amplification, frequency conversion and demodulation, and sends the digital audio signals thus obtained to the communications part 14c; furthermore, this transmission and reception part also sends control signals to the control part 11. Moreover, this transmission and reception part 13 subjects digital audio signals output from the communications part 14c, and control signals output from the control part 11, to modulation, frequency conversion and amplification, thus producing high-frequency signals, and sends these signals to the communications part 12b.

Next, the communications part 14c converts the digital audio signals output from the transmission and reception part 13 into analog audio signals, amplifies these analog audio signals, and sends these signals to the speaker 14a. Furthermore, this communications part 14c amplifies the analog audio signals output from the microphone 14b, converts these signals into digital audio signals, and transmits these digital audio signals to the transmission and reception part 13.

Next, the operation of the display part 15 will be described. In cases where the display part 15 can be visually confirmed by the user, the display part 15 performs a display operation for characters, numerals and image data by the control of the control part 11; the data that is displayed can be switched by receiving input operations from the input device 16 or instructions from the control part 11 in response to call signals. Furthermore, in cases where the display part 15 cannot be visually confirmed, the control part 11 does not control the display operation of the display part 15. Moreover, in cases where the display part 15 cannot be visually confirmed by the user, and in cases where the keys of the input device 16 are not operated by the user and no events occur in the device for a specified period of time, the back lighting of the display part 15 is extinguished by the control part 11. Here, events include the reception of call signals, the ending of communications and the like.

The input device 16 comprises keys including numerical keys used to designate the telephone numbers of communications correspondents, and a plurality of function keys. Furthermore, when an input operation is performed using the keys of the input device 16, the key input is received, the control part 11 is notified of the key discriminators, and characters are displayed on the display part 15 or operations are performed by the control part 11 and the processing part that receives the discriminators via the control part 11.

Next, the operation of the caretaker telephone part 17 will be described. The caretaker telephone part 17 is started by the control part 11 in cases where the control part 11 receives a communications call signal transmitted from the base station, and the discriminator of an operated key from the input device 16 indicating specified calling instructions is not received in spite of the fact that a specified calling sound has been emitted from the speaker 14a and/or a specified vibration has been emitted from the vibrating part (not shown in the figures) for a specified period of time.

Then, in response to the abovementioned call signal, the caretaker telephone part 17 is called up, and transmits (via the communications part 14c) a specified voice message indicating that the call will be recorded since the user cannot come to the telephone. Next, the caretaker telephone part 17 stores the voice message that is received via the communications part 14c in a storage part (not shown in the figures) located inside the caretaker telephone part 17.

Furthermore, the caretaker telephone part 17 is started by the control part 11 as a result of a specified key of the input device 16 being operated by the user, and transmits a list of the voice messages stored inside the caretaker telephone part 17 to the display part 15, where this list is displayed. Then, when the discriminator of a specified key transmitted from the input device 16 is received, one voice message in the displayed list of voice messages is selected, and this selected voice message is played back. Specifically, this message is sent to the speaker 14a via the communications part 14c, and a voice is emitted from the speaker 14a.

Next, the operation of the email transmission and reception part 18 will be described. The email transmission and reception part 18 is a device that performs the transmission and reception of email. Specifically, the email transmission and reception part 18 is started by the control part 11 as a result of the operation of a specified key of the input device 16 by the user, and initiates an email transmission operation.

Then, in accordance with a key discriminator transmitted from the input device 16, the email transmission and reception part 18 prepares email messages (transmission mail) comprising an email destination mail address and main text data. Then, the prepared transmission mail is transmitted to the transmission and reception part 13 via the control part 11. This transmission mail is further transmitted to a mail server device (not shown in the figures) via the communications part 12b, antenna 12a and base station.

Furthermore, the email transmission and reception part 18 receives (via the control part 11) email messages (received mail) that are sent from the mail server device via the base station, antenna 12a, communications part 12b and transmission and reception part 13, stores the received mail that is thus received in the storage part (not shown in the figures) inside the email transmission and reception part 18, and then ends this operation. Furthermore, the email transmission and reception part 18 is started by the control part 11 as a result of the operation of a specified key of the input device 16 by the user, and sends a list of received mail stored in the storage part inside the email transmission and reception part 18 to the display part 15, where this list is displayed. Moreover, when the discriminator of a specified key transmitted from the input device 16 is received, one of the received mail messages is selected, and this selected received mail message is sent to the display part 15 and displayed. As a result of this operation, the user can read received mail.

Next, the operation of the call notification part 21 will be described. The call notification part 21 is started by the control part 11 in cases where the caretaker telephone part 17 stores voice messages received via the communications part 14c in the storage part inside the caretaker telephone part 17, and cases where the email transmission and reception part 18 stores received mail in the storage part inside the email transmission and reception part 18, so that the operation of this part is initiated. In this case, the operation is started without receiving a key discriminator transmitted from the input device 16.

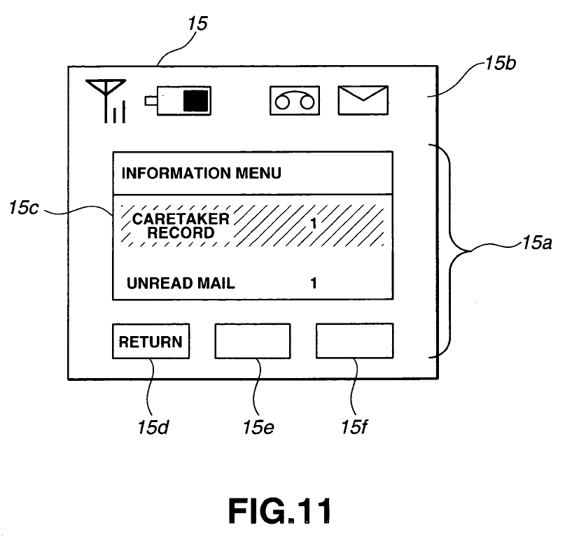

Then, the call notification part 21 displays the number of messages that have not yet been played back and the number of unread mail items on the display part 15. FIG. 11 shows one example of this display. Specifically, a call notification display 15c in which a line comprising the characters “information menu” (as a title), a line comprising the characters “caretaker record” and the number of messages that have not yet been played back and a line comprising the characters “unread mail” and the number of items of unread mail are lined up in the vertical direction is displayed in the processing part display window 15a of the display part 15.

Furthermore, below the processing part display window 15a of the display part 15, a first function display 15d comprising the characters “back”, a second function display 15e which has no characters and a third function display 15f which has no characters are displayed in one line. These first through third function displays 15d through 15f are displays that clearly indicate control instructions received for each processing part in operation (in this case, the call notification part 21) by displaying characters; however, the present invention is not limited to this. For example, these displays may also indicate characters or symbols printed on the keys or the like as information that discriminates the keys that are to be operated in accordance with the received control instructions.

Here, either the abovementioned line including the characters “caretaker record” or the line including the characters “unread mail” is selected, and the call notification part 21 displays the selected line as a display that differs from the other lines. In the example shown in FIG. 11, the line including the characters “caretaker record” is selected, and hatching is shown in this line; however, this “different display” is not limited to the presence or absence of hatching. The line may also be displayed in a different color, or the characters in this line may be displayed in a different color. Then, when the call notification part 21 receives the discriminator of the upward-direction key or downward-direction key of the warp cruciform key 16 b transmitted from the input device 16, the call notification part 21 moves the abovementioned selected line in the upward direction or downward direction in accordance with the key discriminator that is received.

Here, the abovementioned line including the characters “caretaker record” and the line including the characters “unread mail” form a menu. When the discriminator of the warp center key 16a transmitted from the input device 16 is received, in cases where the selected line is the line including the characters “caretaker record”, the call notification part 21 starts the caretaker telephone part 17, causes a list of the recorded voice messages to be displayed, and ends the operation of the call notification part 21. Furthermore, in cases where the abovementioned selected line is the line including the characters “unread mail”, the call notification part 21 starts the email transmission and reception part 18, sends a list of the unread mail to the display part 15 so that this list is displayed, and ends the processing of the call notification part 21.

Here, furthermore, when the discriminator of the first software key 16c transmitted from the input device 16 is received, the call notification part 21 ends the operation in accordance with the function “back” that is displayed as the first function display 15d. When these operations are ended, the call notification display 15c and first through third function displays 15d through 15f displayed in the processing part display window 15a by the call notification part 21 are erased. Furthermore, when the discriminator of the second software key 16d or the discriminator of the third software key 16e is received, the call notification part 21 does not perform processing.

When keys other than the above-described upward-direction key or downward-direction key of the warp cruciform key 16b, the warp center key 16a or the first through third software keys 16c through 16e are operated while the call notification part 21 is in operation, the control part 11 controls the system so that the discriminators of these keys are not transmitted to the call notification part 21.

Furthermore, the call notification part 21 is a processing part that waits for key operations by the user; in cases where the call notification part 21 is in operation, the control part 11 does not start the caretaker telephone part 17 or email transmission and reception part 18 by the operations of keys other than the operation of the abovementioned warp center key 16a. Moreover, there is no starting of the image display part 22.

Furthermore, in the pict window 15b of the display part 15, the control part 11 constantly displays a pict comprising an antenna and 0 to 3 vertical lines which indicates the strength of the received electromagnetic waves, and a pict comprising the shape of a battery which indicates the amount of power accumulated in the charging cell (not shown in the figures). Furthermore, regardless of whether or not the call notification part 21 is in operation, in cases where there are messages that have not yet been played back, the control part 11 displays a pict indicating that such messages are present (e.g., a figure indicting a recording cassette as shown for example in FIG. 11) in the pict window 15b. Furthermore, regardless of whether or not the call notification part 21 is in operation, in cases where there is unread mail, the control part 11 displays a pict indicating that such mail is present (e.g., a figure indicating an envelope as shown for example in FIG. 11) in the pict window 15b.

In the above description, it was considered that the call notification part 21 was started in cases where the caretaker telephone part 17 stored voice messages in the storage part inside the caretaker telephone part 17, and in cases where the email transmission and reception part 18 stored received mail in the storage part inside the email transmission and reception part 18. Furthermore, in these two cases, it was considered that the call notification part 21 caused a list of the stored voice messages to be displayed when an item corresponding to the storage of voice messages in the menu shown by the call notification part 21 was selected, and caused a list of the stored received mail to be displayed when an item corresponding to the storage of received mail was selected. However, the present invention is not limited to this.

For example, it would also be possible to construct a system in which the control part 11 receives communications call signals, stores the telephone numbers of the devices issuing these calls in a storage part (not shown in the figures) inside the control part 11, and is subsequently started in cases where call processing is not performed on the call signals. In this case, the call notification part 21 displays an item indicating that a call signal not called up in the menu shown by the call notification part 21 has been received. Furthermore, when this item is selected, a list of the telephone numbers of devices issuing such calls (received along with the call signals) is displayed.

In other cases as well, the call notification part 21 may be started in cases where the control part 11 receives signals via the base station, and information associated with these received signals is not displayed or heard. Furthermore, the call notification part 21 displays an item indicating that the abovementioned signals have been received in the menu shown by the call notification part 21. Moreover, when this item is selected, the information that is received in association with these signals, a portion of this information or a list of this information is displayed, or a processing part (not shown in the figures) that displays this information is started, so that operation is initiated.

Next, the operation of the image display part 22 will be described. The image display part 22 is a device that performs the playback and display of contents, and operates at a low priority. Specifically, when the image display part 22 is in operation, the control part 11 may temporarily stop the operation of the image display part 22 as a result of the operation of a specified key by the user, or because of some other event, and may cause other processing to be performed (communications processing by the communications part 14c, transmission and reception part 13 or the like, processing of the caretaker telephone part 17, processing of the email transmission and reception part 18 or processing of the call notification part 21).

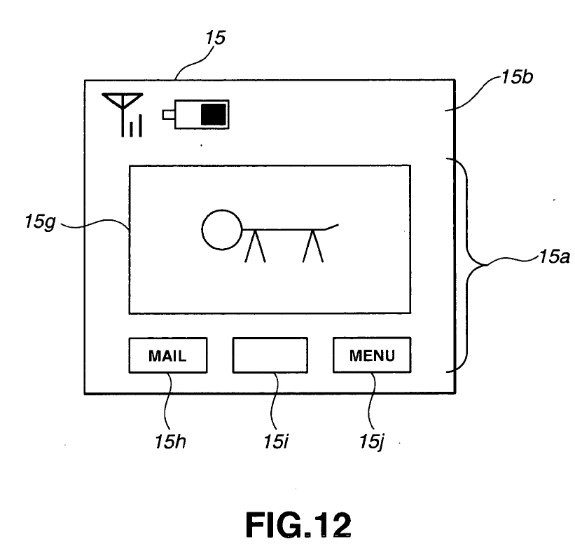

The image processing part 22 initiates operation as a result of being started by the control part 11 due to the operation of a specified key by the user. Furthermore, contents that are stored in the storage part (not shown in the figures) inside the image display part 22 are played back and displayed on the display part 15. FIG. 12 shows one example of the display on the display part 15 that is performed by the image display part 22. Specifically, the image display part 22 displays an image display 15g in which the abovementioned contents are played back in the processing part display window 15a of the display part 15, and displays a line comprising first through third function displays 15h through 15j beneath the image display 15g.

Here, for example, the abovementioned contents comprise animation that consists of the operation of a virtual pet; however, the present invention is not limited to this. The images may be movie images or still images, or still images may be shown in a display that is changed at specified time intervals; furthermore, games may also be displayed. Moreover, conversation with the user may be present or absent. Animation accompanied by conversation with the user, movies or still images whose display is changed at specified time intervals comprise animation or movies in which the subsequent content can be selected by an operation performed by the user, or still images which are subsequently changed so that different still images are displayed.

Furthermore, the abovementioned contents may be contents that include audio information in combination with image information, or contents that do not contain audio information. Such audio information is played back by the image display part 22, and is emitted from the speaker 14a, or from the second speaker (not shown in the figures) disposed on the back surface of the upper or lower housing 1 or 2.

In the example shown in FIG. 12, the character sequence “mail” is displayed in the first function display 15h; in cases where the discriminator of the first software key 16c transmitted from the input device 16 is received, the image display device 22 indicates that a second email transmission and reception part (not shown in the figures) that is built into the image display device 22 is started.

Furthermore, no characters are displayed in the second function display 15i; in case where the discriminator of the second software key 16d is received, the image display part 22 indicates that no processing is performed. Furthermore, the character sequence “menu” is displayed in the third function display 15j; in case where the discriminator of the third software key 16e is received, the image display part 22 indicates that a pop-up menu is displayed over the image display 15g.

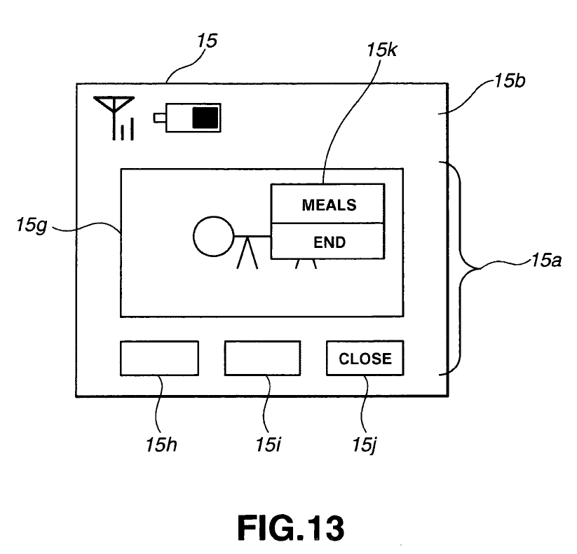

FIG. 13 shows one example of the display that is displayed on the display part 15 when the discriminator of the third software key 16e is received, i.e., one example of the pop-up menu 15k that is displayed. No characters are displayed in the first and second function displays 15h and 15i; in cases where the discriminator of the first or second software key 16c or 16d is received, the image display part 22 indicates that no processing is performed. Furthermore, the character sequence “close” is displayed in the third function display 15j; in cases where the discriminator of the third software key 16e is received, the image display part 22 indicates that the pop-up menu 15k is erased.

The pop-up menu 15k comprises an item in which the character sequence “meals” is displayed and an item in which the character sequence “end” is displayed. This pop-up menu 15k is displayed so that a portion of the image display 15g is hidden. The image display part 22 selects one of the abovementioned two items by receiving either the discriminator of the upward-direction key of the warp cruciform key 16b that is transmitted from the input device 16, or the discriminator of the downward-direction key of this warp cruciform key 16b.

Furthermore, when the discriminator of the warp center key 16a is received, the image display part 22 performs an operation depending on the selected item. Specifically, in cases where the item in which the character sequence “meals” is displayed is selected, an animation in which the virtual pet eats a meal is displayed. On the other hand, in cases where the item in which the character sequence “end” is displayed is selected, the image display part 22 ends the operation. When this operation is ended, the display that was previously displayed in the processing part display window 15a of the display part 15 by the image display part 22 is erased.

Furthermore, the image display part 22 operates at a low priority. Specifically, in specified cases, the control part 11 temporarily stops the operation of the image display part 22. In the case of this temporary stopping, the control part 11 erases the display performed by the image display part 22 that is displayed in the processing part display window 15a of the display part 15, and in cases where audio is being generated, the control part 11 suspends the generation of this audio. In this case, a pict indicating that the image display part 22 has been started (although this is not operating because of a temporary suspension) may be displayed in the pict window 15b.

First of all, the abovementioned specified cases include cases in which an operation is performed by the user. For example, when the control part 11 receives the discriminator of a key other than the first through third function displays 15h through 15j (e.g., the key used to switch the power supply on and off) that is transmitted from the input device 16, the control part 11 temporarily stops the operation of the image display part 22. Then, when the discriminator of a key is received within a specified time following the temporary stopping of the operation, the processing discriminated by this key is initiated.

Examples of such initiated processing include calling processing, call-up processing for received call signals, starting of the caretaker telephone part 17 and starting of the email transmission and reception part 18. When such processing is ended, the control part 11 re-starts the operation of the image display part 22. Furthermore, in cases where a key discriminator is not received within the abovementioned specified period of time, the control part 11 re-starts the operation of the image display part 22. Furthermore, it would also be possible to continue the temporary stopping of the operation of the image display part 22 and the initiation of processing according to the reception of a single key discriminator.

Furthermore, even in cases where an operation is not performed by the user, the control part 11 may (in specified cases) temporarily stop the operation of the image display part 22, and initiate new processing. For example, the abovementioned specified cases include cases in which an arriving call signal is received, cases in which the caretaker telephone part 17 stores received audio in the caretaker telephone part 17, and the call notification part 21 is started, and cases in which the email transmission and reception part 18 receives received mail, and stores this mail in the email transmission and reception part 18, and the call notification part 21 is started. When such new processing is ended, the control part 11 re-starts the operation of the image display part 22.

Furthermore, in the above description, the system was devised so that the control part 11 temporarily stopped the operation of the image display part 22 in specified cases, and erased the display performed by the image display part 22 that was displayed in the processing part display window 15a of the display part 15; however, the present invention is not limited to this. For example, the operation of the image display part 22 may be continued within limits that cause no interference with the new processing in specified cases. Furthermore, in cases where not all of the image display 15g performed by the image display part 22 is hidden by the display performed by this processing (performed in specified cases) in the processing part display window 15a of the display part 15, a display by the image display part 22 may be continued for the portion that is not hidden.

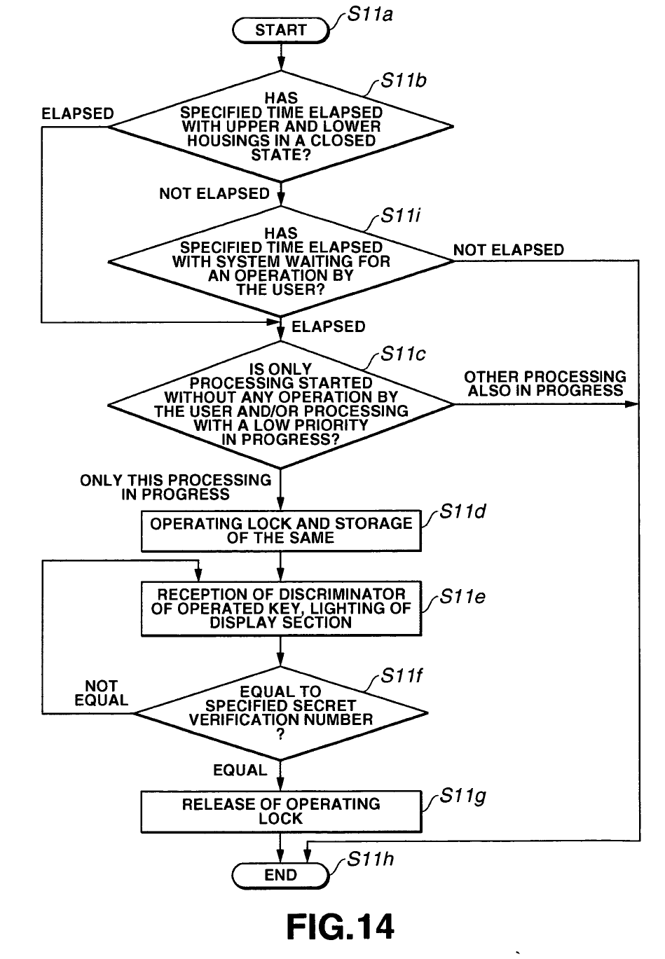

Next, the operating lock and lock release control operation of the control part 11 will be described. FIG. 14 shows a flow chart of the operating lock and lock release operation of the control part 11. This control operation begins to operate at specified time intervals. However, in cases where the control part 11 is already executing this control operation, the operation is not started (step S11a). Then, an open/closed signal 3b is received, and it is investigated by means of this open/closed signal 3b whether or not the upper and lower housings 1 and 2 are in a closed state, and (in accordance with a past open/closed signal 3b stored in the control part 11) whether or not a specified period of time has elapsed since these housings were placed in a closed state (step S11b).

Here, in cases where the specified time is 0, i.e., in cases where the upper and lower housings 1 and 2 are in a closed state, the operating lock and lock release control operation may be performed as described immediately below. Furthermore, the operating lock and lock release control operation of the control part 11 may be started when an open/closed signal 3b indicating that the upper and lower housings 1 and 2 are in a closed state is received in a case where the specified time is 0.

In cases where it is detected in step S11b that the abovementioned specified time has elapsed since the upper and lower housings 1 and 2 were placed in a closed state, the control part 11 investigates the processing that is in progress in the mobile communications terminal device (step S11c). Specifically, the control part 11 ascertains whether or not only processing that is started without an operation being performed by the user, and that waits for an operation by the user (e.g., processing of the call notification part 21), and/or processing that has a low priority (e.g., processing of the image display part 22) is in progress.

Then, in cases where only processing that is started without an operation being performed by the user, and that waits for an operation by the user, and/or processing that has a low priority, is in progress, the control part 11 judges that there is a possibility that the mobile communications terminal device may be left standing; accordingly, the control part 11 places an operating lock on the device, and stores an indication that such an operating lock has been placed on the device in the control part 11 (step S11d). Specifically, even if a key discriminator transmitted from the input device 16 is received, the control part 11 does not allow a new operation to be performed as a result of this reception, and continues only the operating lock and lock release control operation. Furthermore, in cases where an operating lock is placed on the device, when a key discriminator corresponding to a specified operation such as a call-up operation, switching of the power supply on or off, warning notification or the like is received, the control part 11 allows a new operation to be performed in accordance with this operation.

Then, the control part 11 receives the abovementioned key discriminator transmitted from the input device 16, lights the back lighting of the display part 15, and causes a specified display to be performed (step S11e). Furthermore, the system may be devised so that the initiation of a display by lighting the back lighting of this display part 15 is performed in cases where the received key discriminator is a key discriminator that might possibly be used to release the operating lock, and is not performed in cases where this key discriminator is a key discriminator that does not involve such a possibility.

For example, in cases where the input of a secret verification number is required for the release of the operating lock, the keys used for the release of the operating lock are numerical keys only; accordingly, the system may be devised so that the control part 11 performs a display on the abovementioned display part 15 only in cases where numerical key discriminators are received. On the other hand, in cases where a password is required for the release of the operating lock, the keys that are used for the release of the operating lock are keys that are used to input characters; accordingly, the system may be devised so that a display on the abovementioned display part 15 is performed only in cases where discriminators of keys used to input characters are received.

Next, the control part 11 performs a verification operation. Specifically, for example, in cases where the input of a secret verification number is required in order to release the operating lock, the control part 11 ascertains whether or not the information indicated by the key discriminators received in step S11e is equivalent to a secret verification number stored in the control part 11 (step S11f). In cases where the information is equivalent, the operating lock is released (step S11g), and the operating lock and lock release control operation is ended (step S11h). On the other hand, in cases where the information is not equivalent, the discriminators of the keys operated in step S11e are received, and the processing returns to the operation of lighting the display of the display part 15.

In cases where processing other than processing that is started without an operation by the user, and that waits for an operation by the user, and/or processing that has a low priority (e.g., processing of the caretaker telephone part 17, processing of the email transmission and reception part 18, or communications processing) is in progress in step S11c, the control part 11 ends the operating lock and lock release control operation (step S11h).

Furthermore, in step S11b, in cases where the upper and lower housings 1 and 2 are in a closed state, and a specified time has not elapsed since these parts were placed in a closed state, or in cases where the upper and lower housings 1 and 2 are in an open state (“not elapsed” in step S11b), the control part 11 ascertains whether or not a specified time has elapsed since the mobile communications terminal device assumed a state of waiting for a key operation by the user, i.e., a state of waiting for a key discriminator to be transmitted from the input device 16 (step S11i).

Here, the abovementioned specified time may be set so that this time is the same as the specified time to the extinction of the back lighting of the display part 15 by the control part 11 in cases where the user does not operate any key of the input device 16, and no event occurs in the device (as was already described above). Furthermore, when a signal indicating that the back lighting of the display part 15 has been extinguished by the control part 11 is issued, the operating lock and lock release control operation of the control part 11 may be started in accordance with this signal.

In cases where it is judged in step S11i that the abovementioned specified time has elapsed, the control part 11 performs the operation from the investigation of the processing in progress in step S11c on. On the other hand, in cases where it is judged that the abovementioned specified time has not elapsed, the control part 11 ends the operating lock and lock release control operation (step S11h).

In the above description, the system was devised so that the control part 11 performed the operating lock and lock release control operation from step 11c on in cases where a specified time had elapsed from the time that the upper and lower housings 1 and 2 assumed a closed state, and in cases where the period of waiting for an input operation by the user had exceeded a specified period of time. However, it would also be possible to devise the system so that the setting of whether or not the operating lock control operation is performed in either or both of these cases according to a specified key operation by the user can be performed by the user.

Furthermore, in cases where the power supply of the mobile communications terminal device is switched off and then switched on after the operating lock of step S11d has been placed on the device, and the operation of storing an indication of this has been performed, the control part 11 reads out stored information indicating that an operating lock has been placed on the device, and the operating lock and lock release control operation of the control part 11 is executed from step S11e. As a result of this control operation, there is no release of the set operating lock without a verification operation by means of (for example) a secret verification number in step S11f as a result of the power supply being switched off and on. The present invention is not limited to the construction described above; various modifications are possible.

What is claimed is:

1. An information processing device comprising:
a processing control unit configured to execute processing that is started without any operation being performed by a user;
a detection control unit configured to detect the opening and closing of the device; and
a locking control unit configured to lock a key, if a closed state of the device is detected by said detection control unit, and the processing performed by said processing control unit is in progress.

2. The information processing device according to claim 1, wherein said processing control unit is started upon reception of information, displays a table of the received information on a display, and performs a reception notification operation that accepts operation of said displayed information.

3. The information processing device according to claim 1, wherein said locking control unit locks the key, if a state in which the closed state of the device detected by said detection control unit continues for a specified period of time or longer, and the processing performed by said processing control unit is in progress.

4. An information processing device comprising:
a processing control unit configured to execute processing that is started without any operation being performed and that accepts an operation performed;
a judgment control unit configured to judge whether or not a state in which said processing control unit accepts the operation performed has continued for a specified period of time or longer; and
a locking control unit configured to lock a key, if it is judged that the state in which said processing control unit accepts the operation performed has continued for the specified period of time or longer, and the processing performed by said processing control unit is in progress.

5. The information processing device according to claim 4, wherein said processing control unit is started upon reception of information, displays a table of the received information on a display, and performs a reception notification operation that accepts a selection operation of said displayed information.

6. An information processing device comprising:
a processing control unit configured to execute first processing which has a lower priority than second processing based on an operation performed, and which is interrupted if said second processing based on the operation performed is started;
a detection control unit configured to detect the opening and closing of the device; and
a locking control unit configured to lock a key, if a closed state of the device is detected by said detection control unit, and said first processing performed by said processing control unit is in progress.

7. The information processing device according to claim 6, wherein said locking control unit locks the key, if the closed state of the device detected by said detection control unit continues for a specified period of time or longer, and said first processing performed by said processing control unit is in progress.

8. The information processing device according to claim 6, wherein said processing control unit re-starts said first processing as a result of the completion of said second processing based on the operation performed.

9. The information processing device according to claim 6, wherein said processing control unit hides a display on a display section relating to said first processing, and performs a display relating to said second processing on said display section, if said second processing is in progress.

10. The information processing device according to claim 6, wherein said first processing is content reproduction display processing for reproducing and displaying a specified content on the display and said second processing is communications processing for issuing an outgoing call and receiving an incoming call.

11. An information processing device comprising:
a processing control unit configured to execute first processing which has a lower priority than second processing based on an operation performed, and which is interrupted if said second processing based on the operation performed is started;
a judgment control unit configured to judge whether or not a state in which no operation is performed has continued for a specified period of time or longer; and
a locking control unit configured to lock a key, if it is judged by said judgment control unit that the state in which no operation is performed has continued for a specified period of time or longer, and the first processing performed by said processing control unit is in progress.

12. The information processing device according to claim 11, wherein said processing control unit re-starts said first processing as a result of the completion of said second processing based on the operation.

13. The information processing device according to claim 11, wherein said processing control unit hides a display on a display relating to said first processing, and performs a display relating to said second processing on said display, if said second processing is in progress.

14. The information processing device according to claim 11, wherein said first processing is content reproduction display processing for reproducing and displaying a specified content on the display, and said second processing is communications processing for issuing an outgoing call and receiving an incoming call.
